(19) United States
(12) Patent Application Publication
(10) Pub. No.: US 2019/0188772 A1
(43) Pub. Date: Jun. 20, 2019

(54) METHOD AND SYSTEM FOR REAL-TIME NAVIGATIONAL GUIDANCE AND PURCHASE RECOMMENDATIONS

(71) Applicant: Mastercard International Incorporated, Purchase, NY (US)

(72) Inventors: Sai Sudha Venkata CHAGANTI, Ballwin, MO (US); Piruthiviraj SIVARAJ, O'Fallon, MO (US); Joseph WHITE, Wentzville, MO (US)

(73) Assignee: Mastercard International Incorporated, Purchase, NY (US)

(21) Appl. No.: 15/844,888

(22) Filed: Dec. 18, 2017

(51) Int. Cl. G06Q 30/06; G06Q 10/04; G06F 17/30; G01C 21/34; G01C 21/36

(52) U.S. Cl. CPC G06Q 30/0631; G06Q 30/0633; G06Q 10/047; G06Q 10/087; G01C 21/343; G01C 21/3476; G01C 21/3682; G06F 17/30867

(57) ABSTRACT

A method for providing real-time navigational guidance includes: storing merchant profiles, each including a merchant identifier, geographic location, and wait time; storing product profiles, each including a product identifier and participating merchant identifiers; receiving a product list from a computing device, the list including a plurality of product identifiers; identifying, for each of the plurality of product identifiers, a corresponding product profile that includes the respective product identifier; identifying, for each of the plurality of product identifiers, a participating merchant profile that includes a merchant identifier included in the corresponding product profile; generating a navigational guidance plan for purchase of each product indicated in the product list including stops at merchants related to identified participating merchant profiles based on the geographic location and wait time included in the participating merchant profiles; and transmitting the navigational guidance plan to the computing device.

### FIELD

The present disclosure relates to the providing of real-time navigational guidance, specifically the real-time identification of a navigational guidance plan to visit a plurality of merchants for purchase of a selected group of products that optimizes travel and wait time.

### BACKGROUND

When it comes to shopping, consumers often utilize a number of tools to assist in their planning. For instance, many consumers often follow services that provide information on deals and discounts to find a deal on a product they are looking for or to get ideas for a purchase. During busier shopping seasons, such as around Christmas, consumers may utilize a significant number of services to get the best deals possible and to try and get deals on all the products they wish to purchase. At the same time, some consumers may also subscribe to services to give new product ideas to the consumer, such as based on their prior shopping experiences through the service. For example, a merchant may recommend products to the consumer based on prior purchases or their browsing history.

However, these services often provide consumers only with the knowledge of what products the consumer may wish to buy, or what merchants may have deals or discounts on selected products. Many times, particularly during busier shopping seasons, a consumer may discover that they will have to visit several different types of merchants to complete their shopping, where there may be a number of merchants that they could visit to satisfy each type. The consumer is left to their own devices to come up with a plan for selecting these merchants and visiting them. This can result in the creation of an inefficient plan for visiting merchants that results in a significant time loss. In addition, even if the consumer identifies an efficient plan with respect to travel time, the time spent at merchants may vary such that the most efficient plan from a geographic standpoint may still be wildly inefficient from a time standpoint.

Thus, there is a need for a technological solution to identify a navigational guidance plan for a consumer for visiting a plurality of different merchants.

### SUMMARY

The present disclosure provides a description of systems and methods for providing real-time navigational guidance. The systems and methods identify merchants that sell products from a selected list of products supplied by a consumer (which may be selected from a list of products recommended by the same engine based on past consumer purchases or consumer-provided criteria), and may select merchants based on the consumer's location, each merchant's location, and expected wait times at each merchant based on historical data captured from consumers and data provided by the merchants. A real-time navigational guidance plan can be devised based on the location of the consumer and each merchant location that optimizes the travel of the consumer by taking into account not only the location of each merchant but also the wait time, to ensure that their shopping trip is as efficient as possible. In some embodiments, the system may also capture and/or estimate product inventory for each merchant, to also take this into account when making a navigational guidance plan to ensure that, not only is the consumer's trip optimally efficient, but that every product can be successfully purchased, even during a busy shopping season.

A method for providing real-time navigational guidance includes: storing, in a merchant database of a processing server, a plurality of merchant profiles, wherein each merchant profile includes a structured data set related to a merchant including at least a merchant identifier, a geographic location, and a wait time; storing, in a product database of a processing server, a plurality of product profiles, wherein each product profile includes a structured data set related to a product available for purchase including at least a product identifier and one or more participating merchant identifiers; receiving, by a receiving device of the processing server, a product list from a computing device, wherein the product list includes at least a plurality of product identifiers; executing, by a querying module of the processing server, a first query on the product database to identify, for each product identifier of the plurality of product identifiers, a corresponding product profile that includes the respective product identifier; executing, by the querying module of the processing server, a second query on the merchant database to identify, for each product identifier of the plurality of product identifiers, a participating merchant profile that includes a merchant identifier included in the one or more participating merchant identifiers included in the corresponding product profile; generating, by a generation module of the processing server, a navigational guidance plan for purchase of each of products indicated in the product list including stops at one or more merchants related to identified participating merchant profiles based on at least the geographic location and wait time included in each identified participating merchant profile; and electronically transmitting, by a transmitting device of the processing server, the generated navigational guidance plan to the computing device.

A system for providing real-time navigational guidance includes: a merchant database of a processing server configured to store a plurality of merchant profiles, wherein each merchant profile includes a structured data set related to a merchant including at least a merchant identifier, a geographic location, and a wait time; a product database of a processing server configured to store a plurality of product profiles, wherein each product profile includes a structured data set related to a product available for purchase including at least a product identifier and one or more participating merchant identifiers; a receiving device of the processing server configured to receive a product list from a computing device, wherein the product list includes at least a plurality of product identifiers; a querying module of the processing server configured to execute a first query on the product database to identify, for each product identifier of the plurality of product identifiers, a corresponding product profile that includes the respective product identifier, and execute a second query on the merchant database to identify, for each product identifier of the plurality of product identifiers, a participating merchant profile that includes a merchant identifier included in the one or more participating merchant identifiers included in the corresponding product profile; a generation module of the processing server configured to generate a navigational guidance plan for purchase of each of products indicated in the product list including stops at one or more merchants related to identified participating merchant profiles based on at least the geographic location and wait time included in each identified participating merchant profile; and a transmitting device of the processing server configured to electronically transmit the generated navigational guidance plan to the computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating real-time navigational guidance plans with maximum time efficiency in accordance with exemplary embodiments.

FIG. 2 is a block diagram illustrating the processing server of the system of FIG. 1 for providing real-time navigational guidance plans in accordance with exemplary embodiments.

FIG. 3 is a flow diagram illustrating a process for providing real-time navigational guidance to a consumer computing device in the system of FIG. 1 in accordance with exemplary embodiments.

FIG. 4 is a diagram illustrating an example navigational guidance plan provided in the system of FIG. 1 in accordance with exemplary embodiments.

FIG. 5 is a flow chart illustrating an exemplary method for providing real-time navigational guidance in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Real-Time Navigational Guidance and Purchase Recommendations

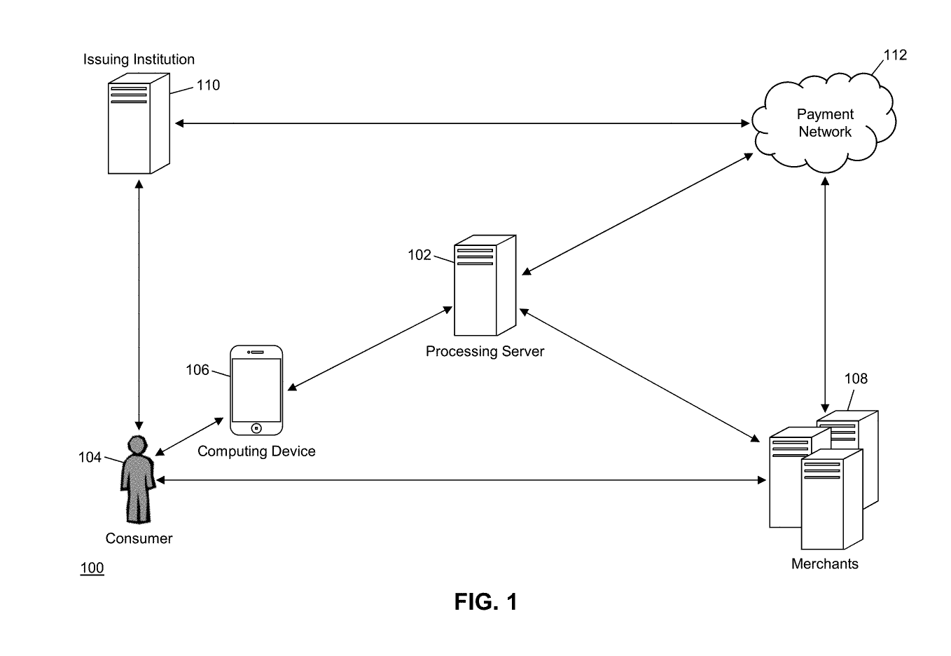

FIG. 1 illustrates a system 100 for the providing of purchase recommendations and associated real-time navigational guidance that utilizes both geographic location and estimated merchant wait time to provide for maximized efficiency.

The system 100 may include a processing server 102. The processing server 102, discussed in more detail below, may be configured to generate and distribute a real-time navigational guidance plan that optimizes efficiency in terms of merchant wait time, travel time, and geographic locations. In the system 100, a consumer 104 may be interested in purchasing one or more products and may request a navigational guidance plan from the processing server 102 accordingly using a computing device 106. The computing device 106 may be any type of computing device suitable for performing the functions discussed herein, such as a desktop computer, laptop computer, notebook computer, tablet computer, cellular phone, smart phone, smart watch, smart television, wearable computing device, implantable computing device, etc. The computing device 106 may be configured to communicate with the processing server 102 using any suitable communication network and method, such as via a web page, application program executed by the computing device 106, application programming interface operated by the processing server 102, short messaging service, multimedia messaging service, e-mail, etc.

The consumer 104 may, using their computing device 108, submit a list of products that they wish to purchase to the processing server 102, where the list includes at least a product identifier for each of the products. The product identifier may be a unique value associated with the product used for identification thereof, such as an identification number, universal product code, stock-keeping unit, European article number, international standard book number, etc. In some embodiments, the consumer 104 may manually generate the list of products. In other embodiments, the processing server 102 may recommend products to the consumer 104, where the consumer 104 may select (e.g., via the computing device 106) the list of products from the recommendations. The identification of recommended products for selection is discussed in more detail below.

The processing server 102 may receive the list of product identifiers from the computing device 106. In some embodiments, the list may be accompanied by a geographic location. The geographic location may be the location of the computing device 106, as identified thereby using suitable methods, or a geographic location selected by the consumer 104. For instance, the consumer 104 may want to use the computing device's location as a starting point for their shopping trip, or may manually select a location where they would like to begin their shopping trip, such as their place of work or a location where they will be running an errand.

The processing server 102 may first identify at least one merchant 108 for each of the selected products that sells the respective product. The processing server 102 may store a profile for each merchant 108, discussed in more detail below, which includes product identifiers corresponding to products offered for purchase at the respective merchant 108. The processing server 102 may use the profiles to identify merchants 108 that sell each of the products selected by the consumer 104. Each merchant profile may also include a geographic location of the associated merchant 108 and a wait time. The wait time may be an average (e.g., mean or median) time spent at the merchant 108 by consumers 104 when shopping. The wait time may be determined based on self-reporting by consumers 104, reporting by merchants 108, analysis performed by the processing server 102 or another entity, or a combination thereof. Wait times may be determined by analysis by, for instance, identifying the geographic location of a computing device 106 that has opted-in for location reporting that is located at a merchant 108 and identifying how long the computing device 106 remains at the merchant location, or identifying a difference in time between a purchase conducted at a neighbor merchant 108 followed by a purchase at the target merchant 108 via the same transaction account. In some instances, a merchant profile may include a plurality of different wait times for a merchant 108, such as different wait times for times of day, days of the week, days of the year, etc., where the processing server 102 may utilize a specific wait time based on the present time or a time selected by the consumer 104 when requesting the navigational guidance plan. In some embodiments, the processing server 102 may request an updated wait time from each merchant 108 during the selection process to ensure the most accurate, real-time reporting of the wait time. In some cases, the processing server 102 may require such reporting of merchants 108 for a merchant 108 to be selected in a navigational guidance plan.

For each of the products selected by the consumer 104, the processing server 102 may then select a single merchant 108 for use in the navigational guidance plan. In cases where only a single merchant 108 offers a product for purchase, that single merchant 108 may be selected. In other cases, the processing server 102 may select a merchant 108 based on a combination of proximity of the merchant's geographic location to the geographic location supplied by the consumer 104 and the merchant's wait time. For instance, a first merchant 108 may be located only ten minutes away from the consumer's start location (or another merchant depending on order of the guidance plan) but have a sixty minute wait time, whereas a second merchant 108 may be twenty minutes away but have only a ten minute wait time, resulting in the second merchant 108 being more optimal for the guidance plan. In some cases, the processing server 102 may be configured to weight wait time and geographic proximity differently based on preferences of the consumer 104. For instance, when the consumer 104 supplies the list of products, they may also indicate preferences with respect to wait time and proximity. For example, one consumer 104 may want to optimize travel time with little or no regard to wait time, while another consumer 104 may want to optimize wait time and not care about travel distance, while yet another consumer 104 may want the most optimal overall time regardless of activity spread. In some embodiments, the processing server 102 may consider travel time as a part of proximity, and may take into account an effect of traffic on travel time if such data is available, where the traffic may be based on the present time or a time selected by the consumer 104 for the navigational guidance plan.

Once the processing server 102 has identified a merchant 108 for each of the products, the processing server 102 may generate a navigational guidance plan. The navigational guidance plan may be a plan for visitation of each of the merchants 108 identified that would enable the consumer 104 to efficiently visit each of the merchants 108 to purchase every product from their selected list of products while minimizing a combination of travel and wait time (e.g., in a manner that may be selected by the consumer 104). In some embodiments, the navigational guidance plan may be a list of the merchants 108 for use by the consumer 104. In other embodiments, the navigational guidance plan may be a graphical image of a geographic area encompassing the start geographic location and the geographic location each of the merchants 108 where the geographic location of the merchants 108 may be identified in addition to an indication of the optimal order of visitation of the merchants 108. In yet another embodiment, the navigational guidance plan may be a data file configured for use by a geographic positional service application program executed by the computing device 106 to provide real-time navigation to the consumer 104 based on the guidance plan. The processing server 102 may distribute the navigational guidance plan to the consumer 104 via the computing device 106 using a suitable communication method.

The computing device 106 may display the navigational guidance plan to the consumer 104, enabling the consumer 104 to navigate to each of the identified merchants 108 to purchase each product on their list in the most efficient manner possible. The consumer 104 may visit each merchant 108 on the list and purchase one or more products. In some embodiments, the processing server 102 may be configured to receive data regarding purchase made by the consumer 104. In an exemplary embodiment, the consumer 104 may opt-in to a service provided by the processing server 102 to enable the collection of the transactional data by the processing server 102.

In such embodiments, the consumer 104 may have access to a transaction account issued to the consumer 104 or other entity having authorized the consumer 104 by an issuing institution 110. The issuing institution 110 may be a financial institution, such as an issuing bank, or other entity configured to issue transaction accounts to consumers 104 for use in funding payment transactions. As part of the issuing of the transaction account, the consumer 104 may be issued a payment card or other type of payment instrument. The consumer 104 may provide the payment instrument to the merchant 108 at the time of the transaction, where the merchant 108 may identify payment credentials from the payment instrument, which may be submitted along with other transaction data to a payment network 112 either directly via payment rails associated therewith or through one or more intermediate entities, such as an acquiring financial institution or gateway processor. The payment network 112 may receive the payment credentials and other transactional data and may process the payment transaction using traditional methods and systems.

The payment network 112 may provide transaction data to the processing server 102 for payment transactions involving the consumer 104. In some embodiments, the consumer 104 may opt-in to the processing server 102 obtaining the primary account number for the transaction account used by the consumer 104, where the primary account number may be used to identify payment transactions conducted by the consumer 104. In other embodiments, an alternative identification method may be used, such as the replacement of the primary account number with an alternative identifier that may be swapped in the transaction data by the payment network 112 or other authorized third party entity. The processing server 102 may receive the transaction data for each of the payment transactions conducted by the consumer 104, which may be saved in a profile associated with the consumer 104, discussed in more detail below. The transaction data may include any data captured in the payment transaction that may be suitable for use in performing the functions discussed herein, such as a transaction time and/or date, transaction amount, merchant identifier, merchant category code, geographic location, product identifiers, reward data, loyalty data, offer data, etc.

The processing server 102 may be configured to use the transactional data received for a consumer 104 in providing recommendations for new merchants 108 and/or products. The consumer 104 may, via the computing device 106, request recommendations of products for purchase, such as for a birthday or during the holiday shopping season. The processing server 102 may identify past payment transactions conducted by the consumer 104 and identify products based on the products purchased in the earlier transactions. In some cases, the processing server 102 may only utilize related transaction data, such as transactions occurring at the same time the previous year for birthdays or holidays, so as to have a greater degree of accuracy. In some cases, the consumer 104 may provide additional criteria for use in identifying product recommendations. For instance, the consumer 104 may provide a category of products (e.g., jewelry), a price range, or other criteria to be considered by the processing server 102. In some embodiments, the processing server 102 may be configured to identify only products that are on sale or otherwise subject to discount by merchants 108, where the processing server 102 may include such information in a list of recommended products that is transmitted to the consumer 104. The processing server 102 may communicate all recommended products and corresponding product identifiers to the computing device 106 for presentation to the consumer 104. The consumer 104 may then select from the list when providing a list of product identifiers to the processing server 102 for use in generating a navigational guidance plan.

In some embodiments, the processing server 102 may be further configured to utilize inventory data of merchants 108 when generating a navigational guidance plan. In a first embodiment, merchants 108 may report product inventory data to the processing server 102, such as by electronically transmitting data pairs consisting of a product identifier and its corresponding inventory amount. In some cases, merchants 108 may be required to report their inventory in order to be selected as a merchant 108 for inclusion in the navigational guidance plan. In a second embodiment, the processing server 102 may be configured to estimate product inventory at a merchant 108. The estimate may be based on transaction data for a merchant 108 received from the payment network 112, where the processing server 102 may estimate the inventory of a product based on its inclusion in payment transactions involving the merchant 108. For example, the processing server 102 may identify that ten of a product are purchased each day at a merchant 108 and may thus estimate that the merchant 108 carries ten of that product daily. The processing server 102 may update the estimated inventory as new transaction data is received (e.g., to deduct one for each transaction involving a purchase of that product on that day), or may update the estimated inventory over time, such as to account for predicted purchases based on historical transaction data. For example, if an inventory depletes around the same time every day, the estimated inventory of that product at the merchant 108 may be updated accordingly.

The processing server 102 may be configured to take inventory data into account when generating a navigational guidance plan. For instance, when selecting merchants 108 for inclusion in the guidance plan, the processing server 102 may only select merchants 108 that have a positive or non-zero inventory for a product. In some cases, the level of inventory for a merchant 108 may be taken into account. For instance, the processing server 102 may select one merchant 108 over another due to a higher inventory volume, to ensure that the consumer 104 will be able to successfully purchase the product. In some such cases, the inventory level may be weighted as a factor in addition to wait time and geographic location. For example, inventory may be used if there is a minimal difference in wait time, but may be disregarded if it would require a significant detour for the consumer 104. In some instances, the consumer 104 may provide preferences when submitting the list of product identifiers regarding inventory. For example, a consumer 104 may request that only merchants 108 with a large inventory for a product may be selected or may specify extra time the consumer 104 is willing to travel if a larger inventory is identified. In some cases, the processing server 102 may be configured to request real-time inventory updates for selected products from merchants 108 when making selections for the navigational guidance plan. In an exemplary embodiment, the processing server 102 may use product inventory estimates for products based on the expected time of visitation of the merchant 108 based on the navigational guidance plan. For example, if the navigational guidance plan is expected to take several hours (e.g., based on wait times and geographic locations), the inventories for merchants 108 near the end of the plan may drastically differ from the beginning of the plan, and thus estimates of the merchant inventories at the later time may be considered.

The methods and systems discussed herein enable a specifically configured processing server 102 to generate a navigational guidance plan for a consumer 104 that maximizes efficiency for visiting a plurality of different merchants 108 that takes into account both geographic location and wait time. The result is that the consumer 104 is able to maximize the use of his or her time, and if additional preferences are supplied by the consumer 104, can do so in a manner specifically tailored to their liking. This may be beneficial to even those consumers 104 who are proficient when it comes to route-planning as wait times may be unknown to the consumer 104, particularly during busier shopping times. In embodiments where inventory information is utilize by the processing server 102, additional benefits may be provided to consumers 104 to ensure a successful shopping trip. As a result, consumer 104 shopping efficiency may be drastically increased. Furthermore, widespread use of optimized navigational guidance plans may result in decreased road traffic and wait times at merchants 108 due to more efficient shopping behaviors by consumers 104.

### Processing Server

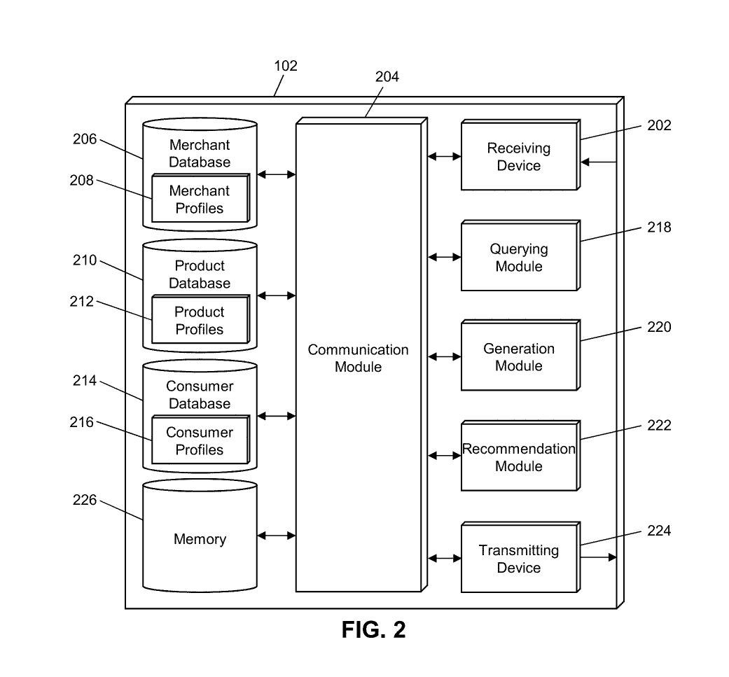

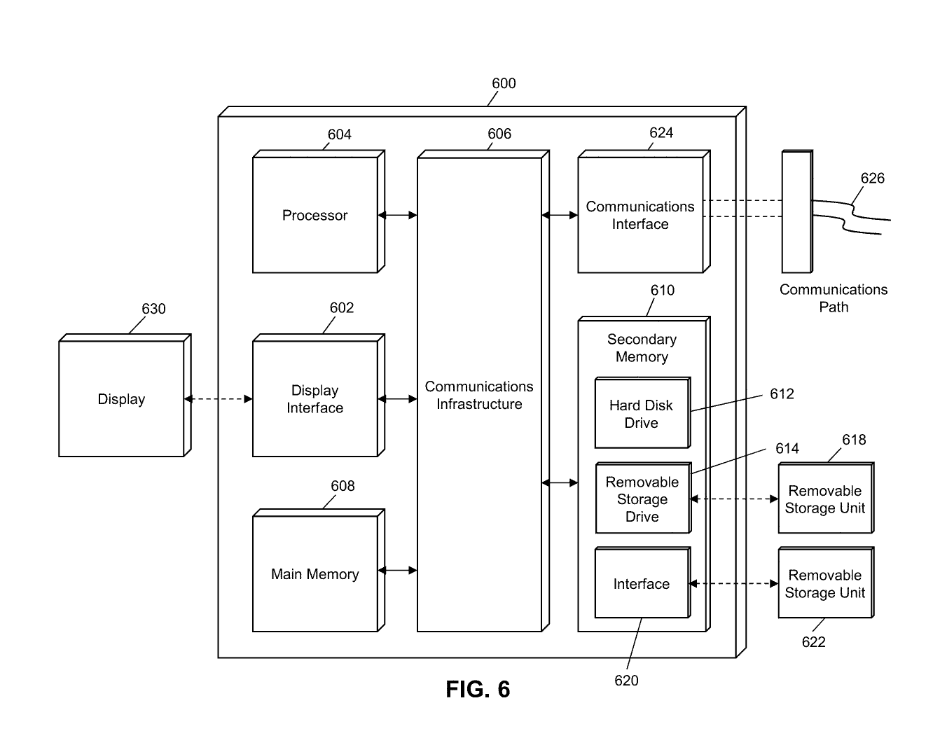

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 106, merchants 108, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 106 that may be superimposed or otherwise encoded with a list of product identifiers. In some cases, the list of product identifiers may be accompanied by a geographic location, a time and/or date, user preferences, and other data that may be used by the processing server 102 in identifying a navigational guidance plan as discussed herein. The receiving device 202 may be configured to receive data signals electronically transmitted by merchants 108, which may be superimposed or otherwise encoded with inventory data, wait time data, geographic locations, or other data for use by the processing server 102 as discussed herein. In some embodiments, the receiving device 202 may be configured to receive data signals electronically transmitted by a payment network 112, which may be transmitted via payment rails associated therewith, that may be superimposed or otherwise encoded with transaction data for payment transactions. The transaction data may include at least an identification value suitable for use in identifying a transaction account or other consumer account. In some instances, the transaction data may be included in a transaction message used in the processing of the payment transaction that is provided to the processing server 102. The transaction message may be a specially formatted transaction message that is compliant with one or more standards governing the exchange of financial transaction messages, such as the ISO 8583 or ISO 20022 standards, which may be communicated using specialized infrastructure of the payment network 112, such as the payment rails. In some such embodiments, the processing server 102 may be a part of the payment network 112.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, recommendation module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a merchant database 206. The merchant database 206 may be configured to store a plurality of merchant profiles 208 using a suitable data storage format and schema. The merchant database 206 may be a relational database that utilizes structured query language for the storage, identification, modifying, updating, accessing, etc. of structured data sets stored therein. Each merchant profile 208 may be a structured data set configured to store data related to a merchant 108 and may include at least a merchant identifier, geographic location, and wait time. The merchant identifier may be a unique value associated with the merchant, such as a merchant identification number. The geographic location may be physical location of the merchant 108 in any suitable representation, such as street address, latitude and longitude, etc. The wait time may be an average time spent at the merchant 108 by consumers 104 when participating in a payment transaction therewith. In some cases, a merchant profile 208 may also include inventory data, which may consist of pairs of product identifiers and current inventory of the related product at the respective merchant 108. In some instances, the inventory data may be comprised of a plurality of estimated inventories for a product over time.

The processing server 102 may also include a product database 210. The product database 210 may be configured to store a plurality of product profiles 212 using a suitable data storage format and schema. The product database 210 may be a relational database that utilizes structured query language for the storage, identification, modifying, updating, accessing, etc. of structured data sets stored therein. Each product profile 212 may be a structured data set configured to store data related to a product and may include at least the product identifier associated with the related product and one or more merchant identifiers. Each merchant identifier may be associated with a merchant 108 where the related product may be purchased. In some cases, a product profile 212 may include inventory data regarding inventory of the related product at each of the merchants 108 where the product may be purchased. In some such cases, the inventory data may be estimated and may include estimate of inventory data at a plurality of different times and/or dates.

The processing server 102 may also include a consumer database 214. The consumer database 214 may be configured to store a plurality of consumer profiles 216 using a suitable data storage format and schema. The consumer database 214 may be a relational database that utilizes structured query language for the storage, identification, modifying, updating, accessing, etc. of structured data sets stored therein. Each consumer profile 216 may be a structured data set configured to store data related to a consumer 104 and include at least an identification value (e.g., a primary account number or other identifier). In embodiments where recommendations may be provided by the processing server 102, the consumer profile 216 may include transaction data for payment transactions involving the related consumer 104 and/or criteria provided by the consumer 104 for use in identifying recommendations. In some cases, the consumer profile 216 may be configured to store data regarding requested navigational guidance plans, such as consumer preferences for use in generating future guidance plans.

The processing server 102 may include a querying module 218. The querying module 218 may be configured to execute queries on databases to identify information. The querying module 218 may receive one or more data values or query strings, and may execute a query string based thereon on an indicated database, such as the product database 210, to identify information stored therein. The querying module 218 may then output the identified information to an appropriate engine or module of the processing server 102 as necessary. The querying module 218 may, for example, execute a query on the product database 210 to identify product profiles 212 for each product identifier included in a received list of selected products, and then may execute queries on the merchant database 206 to identify merchant profiles 208 for each product based on merchant identifiers included in the corresponding product profiles 212.

The processing server 102 may also include a generation module 220. The generation module 220 may be configured to generate data for use by the processing server 102 in performing the functions discussed herein. The generation module 220 may receive an instruction, may generate data based on that instruction, and may output the generated data to another module or engine of the processing server 102. The generation module 220 may be configured to generate navigational guidance plans. The navigational guidance plan may include a plurality of different merchant locations and may enable a consumer 104 to efficiently navigate to each of the merchant locations to purchase all of the products on a supplied list of selected products in a manner that maximizes efficiency with respect to geographic location and wait time, in a ratio preferred by the consumer 104, if applicable. As part of the generation of the navigational guidance plan, the generation module 220 may be configured to select a merchant 108 from a plurality of merchants 108 that offer a product for purchase based on any suitable criteria discussed herein, such as geographic location, wait time, product inventory, consumer preference, or a combination thereof. In some embodiments, the generation module 220 may be configured to generate estimated wait times based on transaction data, as well as generating estimated product inventories based on transaction data.

The processing server 102 may also include a recommendation module 222. The recommendation module 222 may be configured to generate recommendations for the processing server 102 for performing the functions discussed herein. The recommendation module 222 may receive instructions as input, may make one or more recommendations based on the instructions, and may output the recommendation(s) to another module or engine of the processing server 102. In some instances, the input may include data for use by the recommendation module 222. In other instances, the recommendation module 222 may be configured to identify such data, such as by instructing the querying module 218 or generation module 220 to identify data for use by the recommendation module 222. The recommendation module 222 may be configured to recommend products for purchase by a consumer 104 based on transaction data associated with the consumer 104 (e.g., identifying in their corresponding consumer profile 216).

The processing server 102 may also include a transmitting device 224. The transmitting device 224 may be configured to transmit data over one or more networks via one or more network protocols. In some instances, the transmitting device 224 may be configured to transmit data to computing devices 106, merchants 108, payment networks 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to computing devices 106 that are superimposed or otherwise encoded with navigational guidance plans. In embodiments where the processing server 102 is configured to identify recommended products for purchase, data signals electronically transmitted to computing devices 106 may be superimposed or otherwise encoded with product identifiers for recommended products. The transmitting device 224 may also be configured to electronically transmit data signals to merchants 108 that are superimposed or otherwise encoded with requests for wait times and, if applicable, inventory data for one or more products. In some embodiments, the transmitting device 224 may be configured to electronically transmit data signals to a payment network 112 that are superimposed or otherwise encoded with a request for transaction data, which, in some instances, may include an account identifier associated with a transaction account and/or consumer profile 216 for use in identifying transaction messages associated therewith.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, map data, traffic data, travel time information, product selection algorithms, etc.

### Process for Provisioning of a Real-Time Navigational Guidance Plan

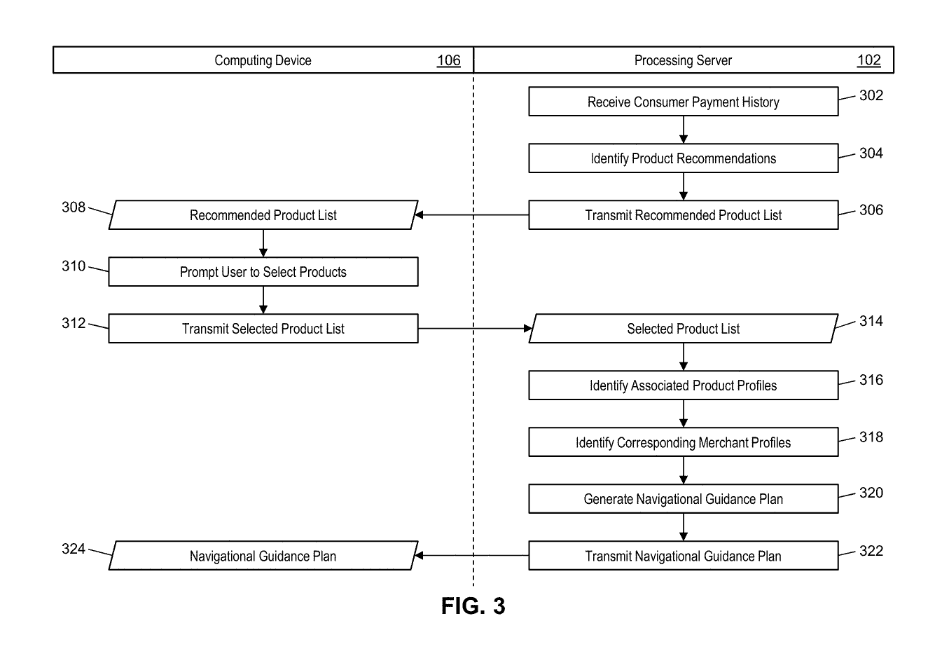

FIG. 3 illustrates a process for the identification and distribution of a navigational guidance plan in real-time for purchase of a plurality of different products at a plurality of different merchants that optimizes efficiency.

In step 302, the receiving device 202 of the processing server 102 may receive transaction data for payment transactions involving the consumer 104 from the payment network 112. In some cases, the transaction data may be included in transaction messages used in the processing of the payment transactions by the payment network 112. In step 304, the recommendation module 222 of the processing server 102 may identify a plurality of different products recommended for purchase by the consumer 104 based on their purchase history as identified in the transaction data for the consumer 104. In some instances, the recommendations may also take into account additional criteria supplied by the consumer 104, such as criteria regarding product categories, product brands, transaction amounts, etc.

In step 306, the transmitting device 224 of the processing server 102 may electronically transmit a list of the recommended products to the computing device 106 associated with the consumer 104 using a suitable communication method and network. The list may include at least the product identifier for each of the recommended products, and may also include additional product data (e.g., name, brand, description, color, size, price, etc.). In step 308, the computing device 106 may receive the list of recommended products, which may be displayed to the consumer 104 via a suitable display device interfaced therewith. In step 310, the computing device 106 may prompt the consumer 104 to select a plurality of different products for purchase. In some cases, the consumer 104 may also be prompted to provide a geographic location or other criteria and/or preferences for their guidance plan, such as a time and/or date, location or wait time preferences, inventory preferences, etc. The consumer 104 may answer the prompt(s) and, in step 312, the computing device 106 may electronically transmit the list of selected products, and any other supplied information, to the processing server 102.

In step 314, the receiving device 202 of the processing server 102 may receive the list of selected products, which may include at least the product identifier associated with each of the selected products, and may include any additional information provided by the computing device 106 and/or consumer 104, such as a geographic location and preferences regarding inventories and wait times. In step 316, the querying module 218 of the processing server 102 may execute a query on the product database 210 of the processing server 102 to identify, for each selected product, a product profile 212 that includes the corresponding product identifier. In step 318, the querying module 218 of the processing server 102 may execute one or more queries on the merchant database 206 of the processing server 102 to identify at least one merchant profile 208 for each selected product that includes a merchant identifier included in the respective associated product profile 212. In instances where multiple merchant profiles 208 may be identified for a product, the processing server 102 may select a single merchant profile 208 based on a combination of geographic location, wait time, product inventory, and consumer preferences, as such information is available and/or applicable. In some embodiments, the processing server 102 may be configured to get updates of inventories and wait times from the merchants 108 in real-time for use in making the selection.

In step 320, the generation module 220 of the processing server 102 may generate a navigational guidance plan for purchase of the selected products at the identified merchants 108. The navigational guidance plan may be at least an ordering of the identified merchants 108 for travel by the consumer 104 to visit each of the merchants 108 to be able to purchase all of the selected products in an outing in the most efficient manner possible. In some cases, the generation module 220 may generate a map that identifies each merchant geographic location and/or the generated navigational path. In some instances, a data file suitable for use by the computing device 108 or other device in assisting the consumer 104 with navigation may be generated. In step 322, the transmitting device 224 of the processing server 102 may electronically transmit the generated navigational guidance plan to the computing device 106, for receipt thereby, in step 324. The consumer 104 may then navigate to each of the merchants 108 as indicated in the plan.

### Navigational Guidance Plan

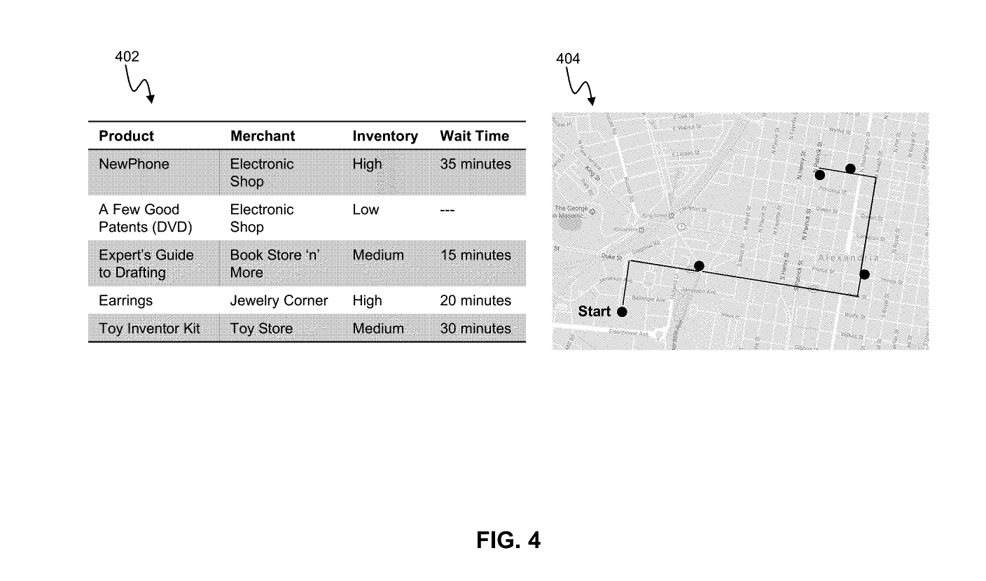

FIG. 4 illustrates an example navigational guidance plan generated by the processing server 102, such as part of the process illustrated in FIG. 3 and discussed above.

As illustrated in FIG. 4 and discussed above, the processing server 102 may generate a text-based navigational guidance plan 402. The navigational guidance plan 402 may include the list of selected products and, for each product, a single merchant 108 identified as carrying the product. In the illustrated example, inventory and wait time data was used by the processing server 102 to ensure that the consumer 104 would be able to visit each merchant 108 and successfully obtain the respective product, and where wait times provide the consumer 104 with an estimated timeline of their shopping experience and were used in identifying the navigational guidance plan. In the illustrated example, the plan 402 lists each of the merchants 108 in the order that they should be visited by the consumer 104 for maximum efficiency.

As also illustrated in FIG. 4, the processing server 102 may also generate a map 404 that illustrates the navigational guidance plan 402. In the illustrated example, the map 404 identifies each of the five merchants 108 that were selected in the navigational guidance plan and their respective geographic locations. A line is illustrated in the map 404 to provide an optimal travel path for the consumer 104 to take from the first merchant 108, indicated on the map by the “Start” label, to the last merchant 108 in the list. In some cases, the ordering of the merchants 108 in the navigational guidance plan 402 and the map 404 may be adjusted based on expected inventory, traffic, and other data available to the processing server 102 as discussed herein.

### Exemplary Method for Providing Real-Time Navigational Guidance

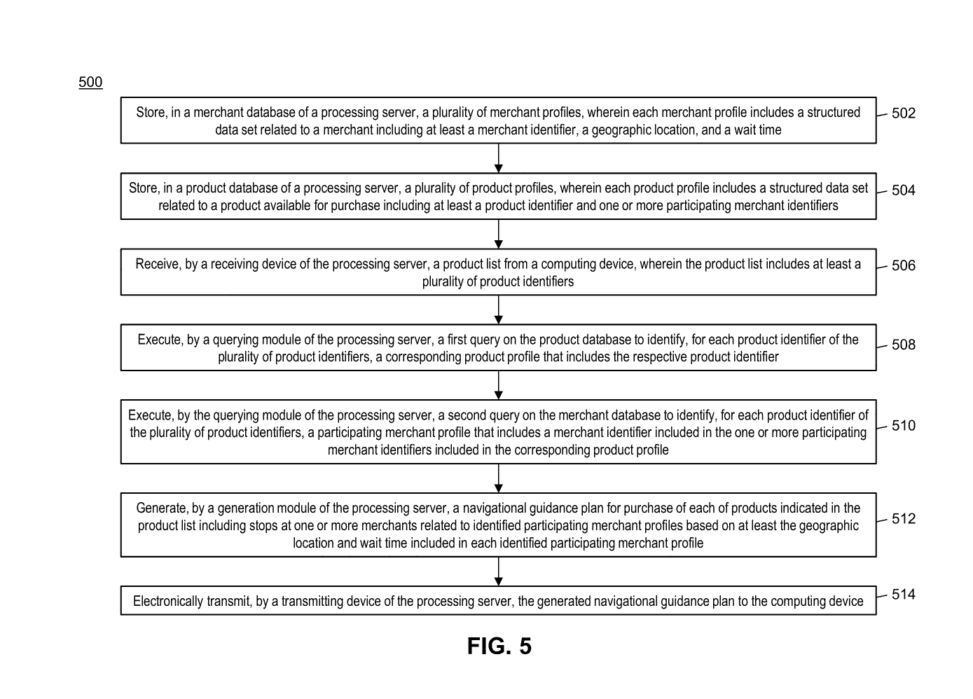

FIG. 5 illustrates a method 500 for the providing of a navigational guidance plan to a user computing device in real-time for the efficient purchase of a plurality of products at a plurality of different merchants that optimizes travel and shopping time.

In step 502, a plurality of merchant profiles (e.g., merchant profiles 208) may be stored in a merchant database (e.g., the merchant database 206) of a processing server (e.g., the processing server 102), wherein each merchant profile includes a structured data set related to a merchant (e.g., a merchant 108) including at least a merchant identifier, a geographic location, and a wait time. In step 504, a plurality of product profiles (e.g., product profiles 212) may be stored in a product database of the processing server, wherein each product profile includes a structured data set related to a product available for purchase including at least a product identifier and one or more participating merchant identifiers.

In step 506, a product list may be received by a receiving device (e.g., the receiving device 202) of the processing server from a computing device (e.g., the computing device 106), wherein the product list includes at least a plurality of product identifiers. In step 508, a first query may be executed on the product database by a querying module (e.g., the querying module 218) of the processing server to identify, for each product identifier of the plurality of product identifiers, a corresponding product profile that includes the respective product identifier. In step 510, a second query may be executed by the querying module of the processing server on the merchant database to identify, for each product identifier of the plurality of product identifiers, a participating merchant profile that includes a merchant identifier included in the one or more participating merchant identifiers included in the corresponding product profile.

In step 512, a navigational guidance plan may be generated by a generation module (e.g., the generation module 220) of the processing server for purchase of each of products indicated in the product list including stops at one or more merchants related to identified participating merchant profiles based on at least the geographic location and wait time included in each identified participating merchant profile. In step 514, the generated navigational guidance plan may be electronically transmitted by a transmitting device (e.g., the transmitting device 224) of the processing server to the computing device.

In one embodiment, the product list may be accompanied by a starting geographic location, and the navigational guidance plan may be further based on the starting geographic location. In some embodiments, each merchant profile may further include one or more product inventory pairs, each product inventory pair may include at least a specific product identifier and a corresponding inventory amount, and each participating merchant profile may include a product inventory pair including the respective product identifier and a non-zero corresponding inventory amount. In a further embodiment, the second query may be configured to identify a single participating merchant profile for each product identifier where an included product inventory pair includes the respective product identifier and has a highest corresponding inventory amount. In another further embodiment, the method 500 may further include: electronically transmitting, by the transmitting device of the processing server, an inventory request to each merchant related to a merchant profile that includes a product inventory pair including one of the plurality of product identifiers; receiving, by the receiving device of the processing server, an updated inventory amount from each merchant in response to the transmitted inventory request; and executing, by the querying module of the processing server, a third query on the merchant database to update the corresponding inventory amount in each merchant profile that includes a product inventory pair based on the updated inventory amount received from the respective merchant, wherein the third query is executed before the second query.

In one embodiment, executing the second query may include identifying a plurality of merchant profiles for each product identifier that includes a merchant identifier included in the one or more participating merchant identifiers included in the corresponding product profile, and selecting a single participating merchant profile from the identified plurality of merchant profiles based on the included geographic location. In a further embodiment, the product list may be accompanied by a starting geographic location, and the single participating merchant profile selected for each product identifier may be based on proximity of the included geographic location and the starting geographic location. In some embodiments, the navigational guidance plan may include a plurality of time estimates based on differences in the geographic location included in each identified participating merchant profile and the wait time included in each identified participating merchant profile.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for providing real-time navigational guidance. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing real-time navigational guidance, comprising:
storing, in a merchant database of a processing server, a plurality of merchant profiles, wherein each merchant profile includes a structured data set related to a merchant including at least a merchant identifier, a geographic location, and a wait time;
storing, in a product database of a processing server, a plurality of product profiles, wherein each product profile includes a structured data set related to a product available for purchase including at least a product identifier and one or more participating merchant identifiers;
receiving, by a receiving device of the processing server, a product list from a computing device, wherein the product list includes at least a plurality of product identifiers;
executing, by a querying module of the processing server, a first query on the product database to identify, for each product identifier of the plurality of product identifiers, a corresponding product profile that includes the respective product identifier;
executing, by the querying module of the processing server, a second query on the merchant database to identify, for each product identifier of the plurality of product identifiers, a participating merchant profile that includes a merchant identifier included in the one or more participating merchant identifiers included in the corresponding product profile;
generating, by a generation module of the processing server, a navigational guidance plan for purchase of each of products indicated in the product list including stops at one or more merchants related to identified participating merchant profiles based on at least the geographic location and wait time included in each identified participating merchant profile; and
electronically transmitting, by a transmitting device of the processing server, the generated navigational guidance plan to the computing device.

2. The method of claim 1, wherein
the product list is accompanied by a starting geographic location, and
the navigational guidance plan is further based on the starting geographic location.

3. The method of claim 1, wherein
each merchant profile further includes one or more product inventory pairs, each product inventory pair including at least a specific product identifier and a corresponding inventory amount, and
each participating merchant profile includes a product inventory pair including the respective product identifier and a non-zero corresponding inventory amount.

4. The method of claim 3, wherein the second query is configured to identify a single participating merchant profile for each product identifier where an included product inventory pair includes the respective product identifier and has a highest corresponding inventory amount.

5. The method of claim 3, further comprising:
electronically transmitting, by the transmitting device of the processing server, an inventory request to each merchant related to a merchant profile that includes a product inventory pair including one of the plurality of product identifiers;
receiving, by the receiving device of the processing server, an updated inventory amount from each merchant in response to the transmitted inventory request; and
executing, by the querying module of the processing server, a third query on the merchant database to update the corresponding inventory amount in each merchant profile that includes a product inventory pair based on the updated inventory amount received from the respective merchant, wherein
the third query is executed before the second query.

6. The method of claim 1, wherein executing the second query includes
identifying a plurality of merchant profiles for each product identifier that includes a merchant identifier included in the one or more participating merchant identifiers included in the corresponding product profile, and
selecting a single participating merchant profile from the identified plurality of merchant profiles based on the included geographic location.

7. The method of claim 6, wherein
the product list is accompanied by a starting geographic location, and
the single participating merchant profile selected for each product identifier is based on proximity of the included geographic location and the starting geographic location.

8. The method of claim 1, wherein the navigational guidance plan includes a plurality of time estimates based on differences in the geographic location included in each identified participating merchant profile and the wait time included in each identified participating merchant profile.

9. A system for providing real-time navigational guidance, comprising:
a merchant database of a processing server configured to store a plurality of merchant profiles, wherein each merchant profile includes a structured data set related to a merchant including at least a merchant identifier, a geographic location, and a wait time;
a product database of a processing server configured to store a plurality of product profiles, wherein each product profile includes a structured data set related to a product available for purchase including at least a product identifier and one or more participating merchant identifiers;
a receiving device of the processing server configured to receive a product list from a computing device, wherein the product list includes at least a plurality of product identifiers;
a querying module of the processing server configured to
execute a first query on the product database to identify, for each product identifier of the plurality of product identifiers, a corresponding product profile that includes the respective product identifier, and
execute a second query on the merchant database to identify, for each product identifier of the plurality of product identifiers, a participating merchant profile that includes a merchant identifier included in the one or more participating merchant identifiers included in the corresponding product profile;
a generation module of the processing server configured to generate a navigational guidance plan for purchase of each of products indicated in the product list including stops at one or more merchants related to identified participating merchant profiles based on at least the geographic location and wait time included in each identified participating merchant profile; and
a transmitting device of the processing server configured to electronically transmit the generated navigational guidance plan to the computing device.

10. The system of claim 9, wherein
the product list is accompanied by a starting geographic location, and
the navigational guidance plan is further based on the starting geographic location.

11. The system of claim 9, wherein
each merchant profile further includes one or more product inventory pairs, each product inventory pair including at least a specific product identifier and a corresponding inventory amount, and
each participating merchant profile includes a product inventory pair including the respective product identifier and a non-zero corresponding inventory amount.

12. The system of claim 11, wherein the second query is configured to identify a single participating merchant profile for each product identifier where an included product inventory pair includes the respective product identifier and has a highest corresponding inventory amount.

13. The system of claim 11, wherein
the transmitting device of the processing server is further configured to electronically transmit an inventory request to each merchant related to a merchant profile that includes a product inventory pair including one of the plurality of product identifiers,
the receiving device of the processing server is further configured to receive an updated inventory amount from each merchant in response to the transmitted inventory request,
the querying module of the processing server is further configured a third query on the merchant database to update the corresponding inventory amount in each merchant profile that includes a product inventory pair based on the updated inventory amount received from the respective merchant, and
the third query is executed before the second query.

14. The system of claim 9, wherein executing the second query includes
identifying a plurality of merchant profiles for each product identifier that includes a merchant identifier included in the one or more participating merchant identifiers included in the corresponding product profile, and
selecting a single participating merchant profile from the identified plurality of merchant profiles based on the included geographic location.

15. The system of claim 14, wherein
the product list is accompanied by a starting geographic location, and
the single participating merchant profile selected for each product identifier is based on proximity of the included geographic location and the starting geographic location.

16. The system of claim 9, wherein the navigational guidance plan includes a plurality of time estimates based on differences in the geographic location included in each identified participating merchant profile and the wait time included in each identified participating merchant profile.
